(19) United States
(12) Patent Application Publication
(10) Pub. No.: US 2014/0064980 A1
(43) Pub. Date: Mar. 6, 2014

(54) ROTOR BLADES WITH INFUSED PREFABRICATED SHEAR WEBS AND METHODS FOR MAKING THE SAME

(71) Applicant: Markus Peter Griesel, Rheine (DE)

(72) Inventor: Markus Peter Griesel, Rheine (DE)

(73) Assignee: General Electric Company, Schenectady, NY (US)

(21) Appl. No.: 13/599,141

(22) Filed: Aug. 30, 2012

(51) Int. Cl. F03D 11/00; B32B 37/12; F01D 5/14

(52) U.S. Cl. 416/226; 416/230; 156/305; 156/292

(57) ABSTRACT

Rotor blades include a first shell reinforcing fiber structure, a prefabricated shear web reinforcing fiber structure having a first end and a second end, wherein the first end is infused with the first shell reinforcing fiber structure at a resin infused joint, and, a second shell reinforcing fiber structure attached to the first shell reinforcing fiber structure and the second end of the prefabricated shear web reinforcing fiber structure.

### BACKGROUND OF THE INVENTION

The subject matter disclosed herein relates to shear webs and, more specifically, to integrated shear webs and methods for making integrated shear webs for wind turbine rotor blades.

Wind turbines continue to receive attention as environmentally safe and relatively inexpensive alternative energy sources. With this growing interest, considerable efforts have been made to develop wind turbines that are reliable and efficient.

Generally, a wind turbine includes a rotor having multiple rotor blades. The rotor blades are elongated airfoils configured to provide rotational forces in response to wind. The rotor is mounted to a housing or nacelle, which is positioned on top of a truss or tubular tower. Utility grade wind turbines (i.e., wind turbines designed to provide electrical power to a utility grid) can have large rotors (e.g., 30 or more meters in length). In addition, the wind turbines are typically mounted on towers that are at least 60 meters in height. Blades on these rotors transform wind energy into a rotational torque or force that drives one or more generators that may be rotationally coupled to the rotor through a gearbox. The gearbox steps up the inherently low rotational speed of the turbine rotor for the generator to efficiently convert mechanical energy to electrical energy, which is fed into a utility grid. In order to provide the efficient conversion of mechanical energy to electrical energy, the wind turbine utilizes a variety of wind turbine components, such as shafts, gearing components, pitch drives, generator components and other components within the wind turbine driven by rotor blades.

Rotor blades may be very large and typically are fabricated utilizing hand lay-up composite fabrication techniques. For example, one method may infuse two outer shells of glass fiber with resin. Once the two shells have been cured, prefabricated, cured composite shear webs are bonded to a load bearing spar of a first shell of the two shells. The bonding typically takes place utilizing an adhesive, such as epoxy or other suitable adhesive. Once the adhesive bonding the first shell to the shear web has cured, the second shell is attached to the shear web and bonded thereto. Thereafter, the entire assembly is cured to provide a finished rotor blade. However, these adhesive joints can add weight and complexity to the rotor blade and increase time required the fabrication process. In addition, the large number of adhesive joints can also preclude the ability to have tight tolerances and junctions, particularly at junctions between the shell and the shear web of the rotor blade.

Accordingly, alternative integrated shear webs and methods for making the same would be welcome in the art.

### BRIEF DESCRIPTION OF THE INVENTION

In one embodiment, a rotor blade is disclosed. The rotor blade includes a first shell reinforcing fiber structure, a prefabricated shear web reinforcing fiber structure having a first end and a second end, wherein the first end is infused with the first shell reinforcing fiber structure at a resin infused joint, and, a second shell reinforcing fiber structure attached to the first shell reinforcing fiber structure and the second end of the prefabricated shear web reinforcing fiber structure.

In another embodiment, a method for manufacturing a unitary support structure for a rotor blade is disclosed. The method includes disposing a prefabricated shear web reinforcing fiber structure adjacent a shell reinforcing fiber structure, infusing a joint resin between the prefabricated shear web reinforcing fiber structure and the shell reinforcing fiber structure, and, curing the joint resin to infuse the prefabricated shear web reinforcing fiber structure with the shell reinforcing fiber structure at a resin infused joint to form the unitary support structure.

In yet another embodiment, a method for manufacturing a rotor blade is disclosed. The method includes disposing a first end of a prefabricated shear web reinforcing fiber structure adjacent a first shell reinforcing fiber structure, infusing a joint resin between the first end of the prefabricated shear web reinforcing fiber structure and the first shell reinforcing fiber structure, curing the joint resin to infuse the prefabricated shear web reinforcing fiber structure with the first shell reinforcing fiber structure at a resin infused joint, and, attaching a second shell reinforcing fiber structure to the first shell reinforcing fiber structure and the second end of the prefabricated shear web reinforcing fiber structure.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 illustrates an exemplary configuration of a wind turbine according to one or more embodiments shown or described herein;

FIG. 2 illustrates a perspective view of a rotor blade according to one or more embodiments shown or described herein;

FIG. 3 illustrates a cross-section taken along the line 3-3 of FIG. 2 according to one or more embodiments shown or described herein;

FIG. 4 illustrates a resin infused joint according to one or more embodiments shown or described herein;

FIG. 5 illustrates another resin infused joint according to one or more embodiments shown or described herein; and,

FIG. 6 illustrates a method for making a unitary support structure for a rotor blade according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

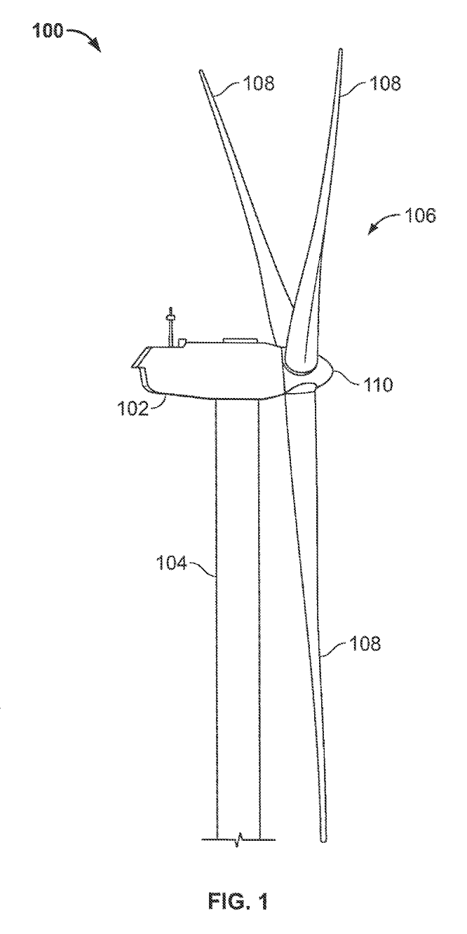

With reference to FIG. 1, a wind turbine 100 is illustrated having a nacelle 102 housing a generator (not shown in FIG. 1). The nacelle 102 is a housing mounted atop a tower 104, only a portion of which is shown in FIG. 1. The height of tower 104 is selected based upon factors and conditions known in the art, and may extend to heights up to 60 meters or more. The wind turbine 100 may be installed on any terrain providing access to areas having desirable wind conditions. The terrain may vary greatly and may include, but is not limited to, mountainous terrain or off-shore locations. Wind turbine 100 also comprises a rotor 106 that includes one or more rotor blades 108 attached to a rotating hub 110. Although wind turbine 100 illustrated in FIG. 1 includes three rotor blades 108, there are no specific limits on the number of rotor blades 108 required by the present disclosure.

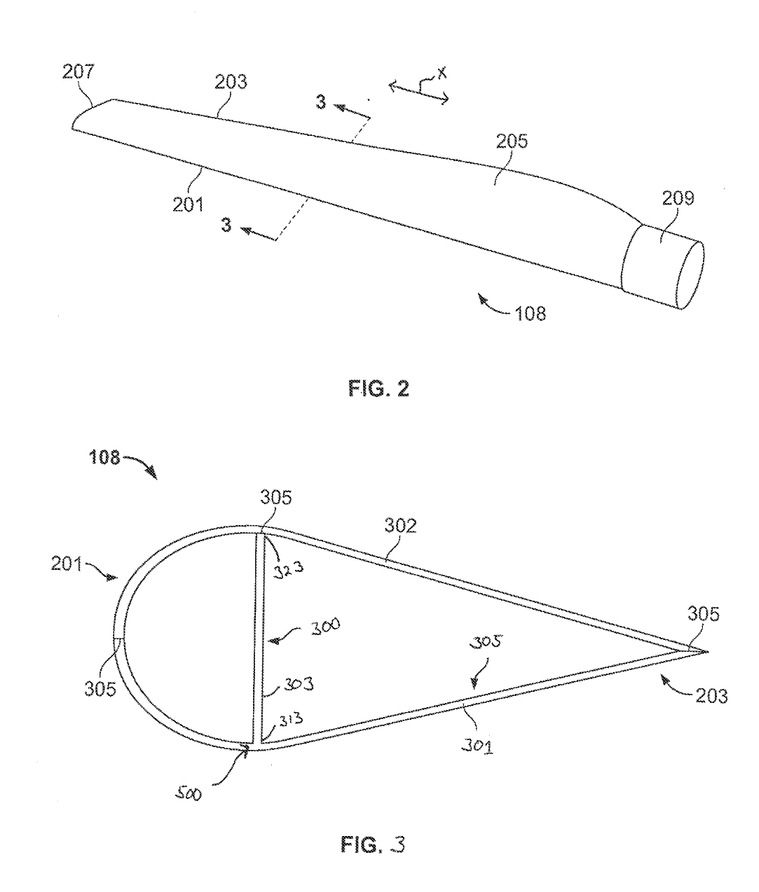

FIG. 2 illustrates a rotor blade 108 having a leading edge 201 and a trailing edge 203. The rotor blade 108 includes an airfoil portion 205 extending from the tip 207 to the root 209, which is connectable to the hub 110 of the wind turbine.

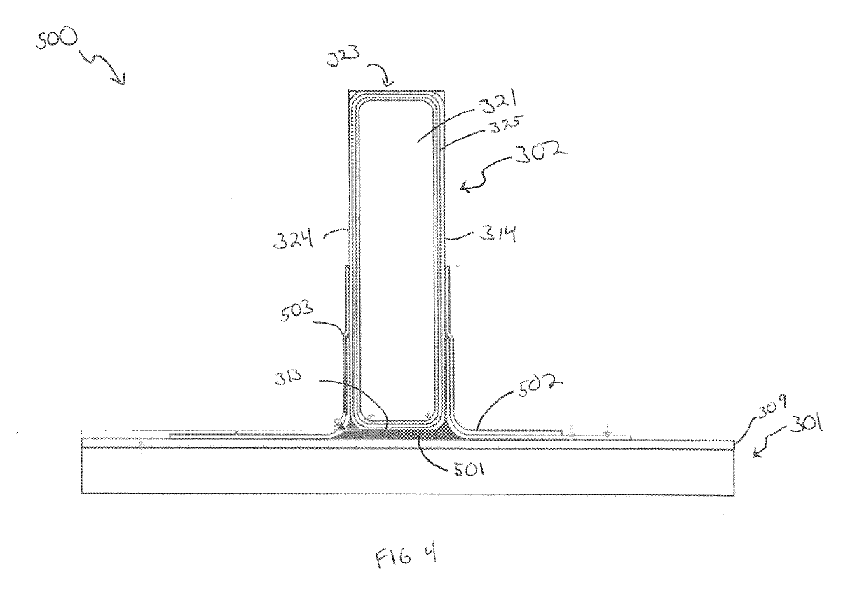

FIG. 3 illustrates a cross-section of the rotor blade 108 taken along line 3-3 of FIG. 2. The rotor blade 108 generally comprises a first shell reinforcing fiber structure 301, a second shell reinforcing fiber structure 302, and a prefabricated shear web reinforcing fiber structure 303. The first shell reinforcing fiber structure 301 can comprise any fiber support structure that may be utilized in a rotor blade 108. In some embodiments, the first shell reinforcing fiber structure 301 can comprise any fiber support structure that is infused with resin (and subsequently cured) at the same time as forming a resin infused joint 500 with the prefabricated shear web reinforcing fiber structure 303 as will become appreciated herein. For example, in some embodiments, the first shell reinforcing fiber structure 301 is formed by an infusion of resin into a reinforcing fabric that may be configured substantially to the desired geometry of the finished first shell reinforcing fiber structure 301. The reinforcing fabric may be provided in any form suitable for providing reinforcement to the composite component, including uniaxial, biaxial, triaxial or quadaxial weaves, braids, chopped strands, rovings or discontinuous fiber mats. Fibers suitable for reinforcement fabric include glass, carbon fiber, synthetic fibers, such as KEVLAR®, or other lightweight reinforcing fibers. Resins can include, for example, any thermosetting or thermoplastic polymer matrix, or combinations thereof, that can be infused into the reinforcing fabric and subsequently cured to produce a reinforcing fiber structure. The resins may optionally comprise any additional additives to facilitate the infusion and curing process such as hardeners, flow additives, or the like. In some embodiments, the first shell reinforcing fiber structure 301 may be prefabricated (such that the resin is already infused into the reinforcing fabric and cured) prior to joining with the prefabricated shear web reinforcing fiber structure 303 as will become appreciated herein. In other embodiments, the first shell reinforcing fiber structure 301 may only comprise the reinforcing fabric and then subsequently be infused with resin and cured while also forming the resin infused joint 500 with the prefabricated shear web reinforcing fiber structure 303 as will also become appreciated herein.

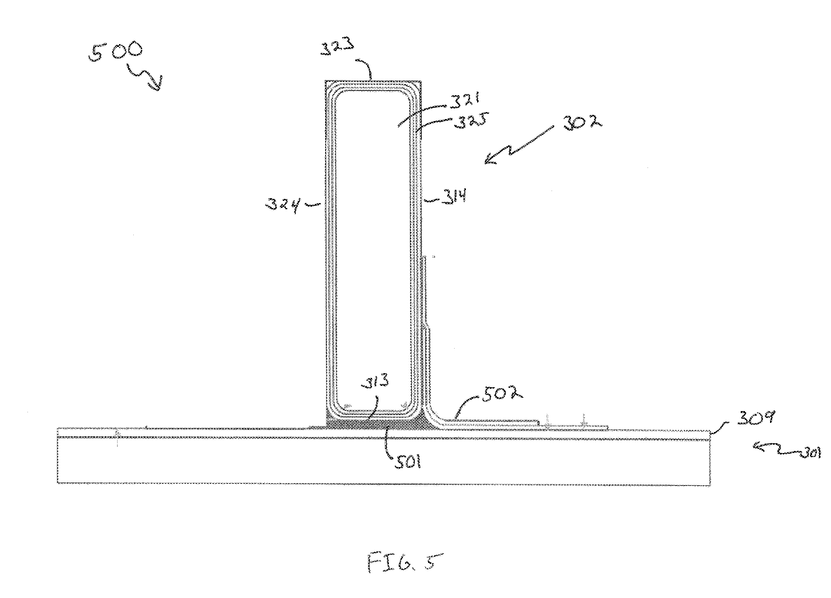

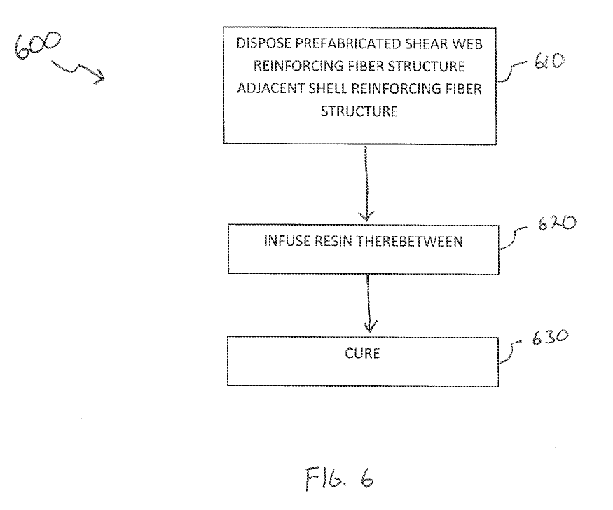

The first shell reinforcing fiber structure 301 can, for example, comprise a variety of components that help make up the exterior shell portion of the rotor blade 108. For example, in some embodiments, the first shell reinforcing fiber structure 301 can comprise a spar cap for the rotor blade 108. In such embodiments, the spar cap may be further connected or integrated with the shell of the rotor blade 108. In other embodiments, the first shell reinforcing fiber structure 301 can comprise the shell itself of the rotor blade 108. In even some embodiments, the first shell reinforcing fiber structure 301 may comprise additional layers, either on the interior or the exterior of the rotor blade 108. For example, in some embodiments, such as that illustrated in the FIGS. 4 and 5, the first shell reinforcing fiber structure 301 may comprise one or more inner skin layers on the interior side of the first shell reinforcing fiber structure 301 (i.e., the side of the first shell reinforcing fiber structure 301 facing the prefabricated shear web reinforcing fiber structure 303).

Referring now to FIGS. 3-5, the prefabricated shear web reinforcing fiber structure 303 can comprise any prefabricated reinforcing fiber structure that can be used to support the interior of the rotor blade 108 between the first shell reinforcing fiber structure 301 and the second shell reinforcing fiber structure 302. As used herein, “prefabricated” refers to a reinforcing fiber structure that has already had resin infused into its reinforcing fabric and been subsequently cured. The reinforcing fiber structure and resin comprising the prefabricated shear web reinforcing fiber structure 303 may comprise any suitable types or combinations such as those described above with reference to the first shell reinforcing fiber structure 301.

In some embodiments, the prefabricated shear web reinforcing fiber structure 303 can comprise additional components or layers. For example, as illustrated in FIGS. 3-5, in some embodiments, the prefabricated shear web reinforcing fiber structure 303 can comprise a core 321. The core 321 can comprise any material that helps provide structure to the prefabricated shear web reinforcing fiber structure 303. For example, in some embodiments, the core 321 can comprise foam, balsa, or the like. The core 321 may then be at least partially surrounded by one or more prefabricated reinforcing fiber layers 325 to provide structural support to the rotor blade 108.

The prefabricated shear web reinforcing fiber structure 303 can have a structure 303 can comprise a “T” shaped cross-section, an “I” shaped cross-section or an “L” shaped cross-section. Moreover, in some embodiments, the prefabricated shear web reinforcing fiber structure 303 can extend for part of or the entire length of the rotor blade 108. However, in some embodiments, the prefabricated shear web reinforcing fiber structure 303 may comprise a plurality of segments disposed about the length of the rotor blade 108.

As best illustrated in FIGS. 4 and 5, the first end 313 of the prefabricated shear web reinforcing fiber structure 303 is infused with the first shell reinforcing fiber structure 301 at a resin infused joint 500. Specifically, the resin infused joint 500 unites the prefabricated shear web reinforcing fiber structure 303 with the first shell reinforcing fiber structure 301 via a single resin infusion bond. As illustrated, joint resin 501 can be disposed between (and potentially around) the first end 313 of the prefabricated shear web reinforcing fiber structure 303 as well as the first shell reinforcing fiber structure 301. The joint resin 501 can include, for example, any thermosetting or thermoplastic polymer matrix or combinations thereof. The joint resin 501 may optionally comprise any additional additives to facilitate the infusion and curing process such as hardeners, flow additives or the like. The joint resin 501 may comprise the same type of resin, some of the same types of resins, or all different resins than those used in the prefabricated shear web reinforcing fiber structure 303 and/or the first shell reinforcing fiber structure 301. The joint resin 501 may be infused into the resin infused joint 500 for either the entire length of the prefabricated shear web reinforcing fiber structure 303, or only parts of the length of the prefabricated shear web reinforcing fiber structure 303. Furthermore, the joint resin 501 may comprise the same type or types of resin for the entire length of the prefabricated shear web reinforcing fiber structure 303, or may vary in type or types of resin over the length of the prefabricated shear web reinforcing fiber structure 303.

In some embodiments, the resin infused joint 500 may comprise additional components to help facilitate its formation. For example, in some embodiments, one or more shear clips 502,503 may be disposed so that they connect the prefabricated shear web reinforcing fiber structure 303 to the first shell reinforcing fiber structure 301. The one or more shear clips 502,503 can comprise one or more glass layers or the like that may help support the various components before, during and/or after the infusion of the joint resin 501. The one or more shear clips 502,503 may thereby be disposed against the prefabricated shear web reinforcing fiber structure 303 and the first shell reinforcing fiber structure 301 prior to the infusion of the joint resin 501. For example, in some embodiments, the one or more shear clips 502,503 may be laminated in place.

Referring to FIGS. 2, 4 and 5, The amount, shape, size and even inclusion of shear clips 502,503 may depend on the location of the prefabricated shear web reinforcing fiber structure 303 along the lengthwise direction x (FIG. 2). Specifically, more or stronger shear clips 502,503 may be included in the resin infused joint 500 closer to the root 209 of the rotor blade 108 than the tip 207 of the rotor blade 108 due to the potentially higher stresses.

For example, as illustrated in FIG. 4, in some embodiments one or more shear clips 502,503 can be disposed on both sides of the prefabricated shear web reinforcing fiber structure 303. Specifically, a first shear clip 502 may be disposed against the first shell reinforcing fiber structure 301 and a first side 314 of the prefabricated shear web reinforcing fiber structure 303. A second shear clip 503 may also be disposed against the first shell reinforcing fiber structure 301 and a second side 324 (opposite the first side 314) of the prefabricated shear web reinforcing fiber structure 303. Including shear clips 502,503 on both sides of the prefabricated shear web reinforcing fiber structure 303 may provide additional support closer to the root 209 of the rotor blade 108, such as within the first 30 meters from the root 209. Conversely, as illustrated in FIG. 5, some embodiments, one or more shear clips 502 may only be disposed against a single side, such as the first side 314 of the prefabricated shear web reinforcing fiber structure 303. Leaving the second side 324 of the prefabricated shear web reinforcing fiber structure 303 void of any shear clips may be utilized closer to the tip 207 of the rotor blade 108 where less stress is present. While specific layouts of shear clips 502,503 have been presented herein, it should be appreciated that these are exemplary only and any other variation in the amount, size and shape of shear clips 502,503 may additionally or alternatively be incorporated in the resin infused joint 500.

In some embodiments, the resin infused joint 500 may comprise a resin flow medium (not illustrated) to assist in the distribution of the joint resin when it is infused. The resin flow medium may comprise any variety of mediums including green meshes (such as the green mesh resin flow media commercially available from Richmond Aerovac). Moreover, the resin flow media may be disposed along the entire length of the prefabricated shear web reinforcing fiber structure 303 or only along one or more parts of the length of the prefabricated shear web reinforcing fiber structure 303.

Referring now to FIGS. 3-5, the resin infused joint 500 can thereby allow the prefabricated shear web reinforcing fiber structure 303 to be infused with the first shell reinforcing fiber structure 301 to form a unitary support structure 300. The unitary support structure 300 can be substantially or entirely devoid of adhesive joints and the resulting joint defects. In some embodiments, (such as those illustrated in FIGS. 3-5), a single prefabricated shear web reinforcing fiber structure 303 may be infused with the first shell reinforcing fiber structure 301 via the resin infused joint 500 to form the unitary support structure 300. However, in other embodiments, multiple prefabricated shear web reinforcing fiber structures 303 may be infused into the same first shell reinforcing fiber structure 301 to form the unitary support structure 300. Moreover, in some embodiments, the first shell reinforcing fiber structure 301 that is infused with the prefabricated shear web reinforcing fiber structure 303 may comprise the pressure side of the rotor blade 108. In other embodiments, the first shell reinforcing fiber structure 301 that is infused with the prefabricated shear web reinforcing fiber structure 303 may comprise the suction side of the rotor blade 108.

Referring back to FIG. 3, the rotor blade 108 further comprises the second shell reinforcing fiber structure 302. The second shell reinforcing fiber structure 302 can comprise any fiber support structure that may be utilized in a rotor blade 108. For example, in some embodiments the second shell reinforcing fiber structure 302 can comprise a prefabricated support structure comprising a reinforcing fabric and resin. The reinforcing fabric and resin may comprise any suitable types or combinations or reinforcing fabrics and resins such as those described above with reference to the first shell reinforcing fiber structure 301.

The second shell reinforcing fiber structure 302 can be attached to the first shell reinforcing fiber structure 301 and the second end 323 of the prefabricated shear web reinforcing fiber structure 303. The attachment can occur through adhesives, bolts, screws or the like. For example, in some embodiments the second shell reinforcing fiber structure 302 can be attached to the first shell reinforcing fiber structure 303 and the second end 323 of the prefabricated shear web reinforcing fiber structure 301 through adhesive joints 305. The adhesive joints 305 can comprise any adhesive compound suitable for connecting composite materials together including, but not limited to, epoxy, polyester, methylacrylate, vinylester or combinations thereof.

While specific examples have been presented herein, it should be appreciated that the geometry of the cross-section of the rotor blade 108 is not limited to the cross-section shown and may include any suitable cross-section that is operable as a rotor blade 108. In addition, the configuration and placement of the prefabricated shear web reinforcing fiber structure 303 is not limited to the position shown and may include any location in which the rotor blade 108 structure is maintained. Furthermore, a spar cap or other reinforcing structure may also be incorporated into the first shell reinforcing fiber structure 301 and/or the second shell reinforcing fiber structure 302.

Referring now to FIG. 6, a method 600 is illustrated for manufacturing a unitary support structure 300 for a rotor blade 108, such as those depicted in FIGS. 1-5. The method 600 first comprises disposing a first end 313 of the prefabricated shear web reinforcing fiber structure 303 adjacent to the first shell reinforcing fiber structure 301. As discussed above, in some embodiments, additional components may be disposed between or adjacent to the two reinforcing fiber structures such as one or more shear clips 502,503 or a resin flow medium. The prefabricated shear web reinforcing fiber structure 303 and the first shell reinforcing fiber structure 301 may be disposed adjacent to one another through a variety of methods such as by using scaffolds, clamps or the like.

The method 600 further comprises infusing a joint resin 501 between the prefabricated shear web reinforcing fiber structure 303 and the first shell reinforcing fiber structure 301. Infusing the joint resin 501 may be achieved through any method that distributes the joint resin 501 throughout the space between (and potentially around) the prefabricated shear web reinforcing fiber structure 303 and the first shell reinforcing fiber structure 301. For example, in some embodiments a vacuum bag may be wrapped around the first shell reinforcing fiber structure 301 and up at least a portion of the prefabricated shear web reinforcing fiber structure 303 to completely seal in at least the volume between two components. A vacuum may then be drawn to distribute the joint resin 501 therein.

Finally, the method 600 further comprises curing the joint resin 501 to infuse the prefabricated shear web reinforcing fiber structure 303 with the first shell reinforcing fiber structure 301 at the resin infused joint 500. Curing may occur at any temperature, for any time and in any environment to harden the joint resin and produce one unitary structure between the prefabricated shear web reinforcing fiber structure 303 and the first shell reinforcing fiber structure 301.

In some embodiments, the method 600 may further comprise forming a rotor blade. In such a case, the method can further include disposing a second shell reinforcing fiber structure 302 adjacent the first shell reinforcing fiber structure 301 and the second end 323 of the prefabricated shear web reinforcing fiber structure 303. The second shell reinforcing fiber structure 302 can then be attached to form the overall rotor blade. The attachment may occur through a variety of methods such as using one or more adhesives at the joints.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A rotor blade comprising:
a first shell reinforcing fiber structure;
a prefabricated shear web reinforcing fiber structure comprising a first end and a second end, wherein the first end is infused with the first shell reinforcing fiber structure at a resin infused joint; and,
a second shell reinforcing fiber structure attached to the first shell reinforcing fiber structure and the second end of the prefabricated shear web reinforcing fiber structure.

2. The rotor blade of claim 1 further comprising at least a first shear clip disposed against the first shell reinforcing fiber structure and a first side of the prefabricated shear web reinforcing fiber structure.

3. The rotor blade of claim 2 further comprising at least a second shear clip disposed against the first shell reinforcing fiber structure and a second side, opposite from the first side, of the prefabricated shear web reinforcing fiber structure.

4. The rotor blade of claim 1, wherein the first shell reinforcing fiber structure comprises a spar cap.

5. The rotor blade of claim 1, wherein the prefabricated shear web reinforcing fiber structure comprises a core at least partially surrounded by one or more prefabricated reinforcing fiber layers.

6. The rotor blade of claim 1, wherein the second shell reinforcing fiber structure is attached to the first shell reinforcing fiber structure and the second end of the prefabricated shear web reinforcing fiber structure at a plurality of adhesive joints.

7. The rotor blade of claim 1 further comprising a resin flow medium disposed in the resin infused joint.

8. The rotor blade of claim 1, wherein the first shell reinforcing fiber structure comprises one or more inner skin layers on its interior side.

9. A method for manufacturing a unitary support structure for a rotor blade, the method comprising:
disposing a prefabricated shear web reinforcing fiber structure adjacent a shell reinforcing fiber structure;
infusing a joint resin between the prefabricated shear web reinforcing fiber structure and the shell reinforcing fiber structure; and,
curing the joint resin to infuse the prefabricated shear web reinforcing fiber structure with the shell reinforcing fiber structure at a resin infused joint to form the unitary support structure.

10. The method of claim 9, wherein the joint resin is also infused into the shell reinforcing fiber structure.

11. The method of claim 9 further comprising disposing at least a first shear clip against the shell reinforcing fiber structure and a first side of the prefabricated shear web reinforcing fiber structure prior to infusing the joint resin.

12. The method of claim 11 further comprising disposing at least a second shear clip disposed against the shell reinforcing fiber structure and a second side, opposite from the first side, of the prefabricated shear web reinforcing fiber structure prior to infusing the joint resin.

13. The method of claim 9 further comprising disposing a resin flow medium between the prefabricated shear web reinforcing fiber structure and the shell reinforcing fiber structure before infusing the joint resin.

14. The method of claim 9, wherein the first shell reinforcing fiber structure comprises a spar cap.

15. A method for manufacturing a rotor blade, the method comprising:
disposing a first end of a prefabricated shear web reinforcing fiber structure adjacent a first shell reinforcing fiber structure;
infusing a joint resin between the first end of the prefabricated shear web reinforcing fiber structure and the first shell reinforcing fiber structure;
curing the joint resin to infuse the prefabricated shear web reinforcing fiber structure with the first shell reinforcing fiber structure at a resin infused joint; and,
attaching a second shell reinforcing fiber structure to the first shell reinforcing fiber structure and the second end of the prefabricated shear web reinforcing fiber structure.

16. The method of claim 15, wherein the joint resin is also infused into the first shell reinforcing fiber structure.

17. The method of claim 15, wherein the second shell reinforcing fiber structure is attached via adhesive joints.

18. The method of claim 15 further comprising disposing at least a first shear clip against the first shell reinforcing fiber structure and a first side of the prefabricated shear web reinforcing fiber structure prior to infusing the joint resin.

19. The method of claim 18 further comprising disposing at least a second shear clip disposed against the first shell reinforcing fiber structure and a second side, opposite from the first side, of the prefabricated shear web reinforcing fiber structure prior to infusing the joint resin.

20. The method of claim 15 further comprising disposing a resin flow medium between the prefabricated shear web reinforcing fiber structure and the first shell reinforcing fiber structure before infusing the joint resin.
